(19) United States
(12) Patent Application Publication
(10) Pub. No.: US 2012/0212579 A1
(43) Pub. Date: Aug. 23, 2012

(54) Method and Arrangement for Multi-View Video Compression

(75) Inventors: Per Fröjdh, Stockholm (SE); Clinton Priddle, Indooroopilly (AU); Thomas Rusert, Kista (SE)

(73) Assignee: TELEFONAKTIEBOLAGET LM ERICSSON (PUBL), Stockholm (SE)

(21) Appl. No.: 13/502,732

(22) PCT Filed: Oct. 18, 2010
(86) PCT No.: PCT/SE2010/051121

§ 371 Date: Apr. 18, 2012

Related U.S. Application Data
(60) Provisional application No. 61/253,092, filed on Oct. 20, 2009.

(51) Int. Cl. H04N 13/00

(52) U.S. Cl. 348/43; 348/E13.072

(57) ABSTRACT

Methods and arrangements for compression and de-compression of N-stream multi-view 3D video in data handling entities, e.g. a data providing node and a data presenting node. The methods and arrangements involve multiplexing (802) of at least some of the N streams of the N-stream multi-view 3D video into one pseudo 2D stream, which appears as a 2D video stream to a 2D encoder. Further, the pseudo 2D stream is provided (804) to a replaceable 2D encoder, for encoding of the pseudo 2D stream, resulting in encoded data having a 2D codec format. This codec-agnostic modular approach to 3D compression and de-compression ensures a fast and convenient access to flexible virtual 3D codecs for handling of N-stream multi-view 3D video.

### TECHNICAL FIELD

The invention relates to a method and an arrangement for video compression, in particular to the handling of multi-view video streams.

### BACKGROUND

In 3D (3-Dimensional) video applications, depth perception is provided to the observer by means of two or more video views. Provision of multiple video views allows for stereoscopic observation of the video scene, e.g. such that the eyes of the observer see the scene from slightly different viewpoint. The point of view may also be controlled by the user.

3D video with two views is referred to as stereo video. Most references to 3D video in media today refer to stereo video. There are several standardized approaches for coding or compression of stereo video. Typically, these standardized approaches are extensions to conventional, previously standardized, 2D (2-Dimensional) video coding.

It is well known, that since a video stream comprises, e.g. between 24 and 60 frames, or images, per second, the motif depicted in the images will probably not have changed much between two successive frames. Thus, the content of consecutive frames will be very similar, which implies that a video stream comprises inter-frame, or “intra-stream”, redundancies. When having multiple views, such as in 3D video, the different views will depict the same motif from slightly different angles, or viewpoints. Consequently, the different views, or streams, will also comprise “inter-view”, or “inter-stream”, redundancies, in addition to the infra-stream redundancies, due to the similarities of the different-angle-images.

One way of coding or compressing the two views of stereo video is to encode each view, or stream, separately, which is referred to as “simulcast”. However, simulcast does not exploit the redundancies between the video views.

### H.264/AVC

Advanced Video Coding (AVC), which is also known as H.264 and MPEG-4 Part 10, is the state of the art standard for 2D video coding from ITU-T (International Telecommunication Union-Telecommunication Standardization Sector) and MPEG (Moving Picture Experts Group) (ISO/IEC JTC1/SC29/WG11). The H.264 codec is a hybrid codec, which takes advantages of eliminating redundancy between frames and within one frame. The output of the encoding process is VCL (Video Coding layer) data which is further encapsulated into NAL (Network Abstraction layer) units prior to transmission or storage.

One approach to compressing stereo video is the “H.264/AVC stereo SEI” or “H.264/AVC frame packing arrangement SEI” approach, which is defined in later releases of the H.264/AVC standard [1]. In the “H.264/AVC stereo SEI”/“H.264/AVC frame packing arrangement SEI” approach, the H.264 codec is adapted to take two video streams as input, which are then encoded in one 2D video stream. The H.264 codec is further adapted to indicate in so called Supplemental Enhancement Information (SEI) messages, that the 2D video stream contains a stereo pair. There are several flags in the SEI message indicating how the two views are arranged in the video stream, including possibilities for spatial and temporal interleaving of views.

### MVC

Further, another approach is MVC (Multi-View Video Coding), which is defined in recent releases of the H.264/AVC specification [1]. In MVC, the simulcast approach is extended, such that redundancies between the two views may be exploited by means of disparity compensated prediction. The MVC bit stream syntax and semantics have been kept similar to the AVC bit stream syntax and semantics.

### MPEG-2 Multiview Profile

The “MPEG-2 multiview profile” (Moving Picture Experts Group) is another standardized approach for stereo coding, using a similar principle as the “MVC” approach The MPEG-2 multiview profile extends the conventional MPEG-2 coding, and is standardized in the MPEG-2 specifications [2].

### View Synthesis

To increase the performance of 3D video coding when many views are needed, some approaches with decoder-side view synthesis based on extra information, such as depth information, have been presented. Among those is MPEG-C Part 3, which specifies signaling needed for interpretation of depth data in case of multiplexing of encoded depth and texture. More recent approaches are Multi-View plus Depth coding (MVD), layered Depth Video coding (IDV) and Depth Enhanced Stereo (DES). All the above approaches combine coding of one or more 2D videos with extra information for view synthesis. MVD, IDV and DES are not standardized.

### 3D Video Coding Standards

3D video coding standards are almost entirely built upon their 2D counterparts, i.e. they are a continued development or extension of a specific 2D codec standard. It may take years after the standardization of a specific 2D video codec until a corresponding 3D codec, based on the specific 2D codec is developed and standardized. In other words, considerable periods of time may pass, during which the current 2D compression standards have far better compression mechanisms than contemporary current 3D compression standards. This situation is schematically illustrated in FIG. 1. One example is the period of time between the standardization of AVC (2003) and the standardization of MVC (2008). It is thus identified as a problem that the development and standardization of proper 3D video codecs are delayed for such a long time.

### SUMMARY

It would be desirable to shorten the time from the development and standardization of a 2D codec until a corresponding 3D codec could be used. It is an object of the invention to enable corresponding 3D compression shortly after the development and/or standardization of a 2D codec. Further, it is an object of the invention to provide a method and an arrangement for enabling the use of any preferred 2D video codec to perform multi-view video compression. These objects may be met by a method and arrangement according to the attached independent claims. Optional embodiments are defined by the dependent claims. The compression and de-compression described below may be performed within the same entity or node, or in different entities or nodes.

According to a first aspect, a method for compressing N-stream multi-view 3D video is provided in a video handling, or video providing, entity. The method comprises multiplexing of at least some of the N streams of the N-stream multi-view 3D video into one pseudo 2D stream, which appears as a 2D video stream to a 2D encoder. The method further comprises providing the pseudo 2D stream to a replaceable 2D encoder, for encoding of the pseudo 2D stream, resulting in encoded data having a 2D encoding or codec format.

According to a second aspect, an arrangement adapted to compress N-stream multi-view 3D video is provided in a video handling, or video providing, entity. The arrangement comprises a functional unit, which is adapted to multiplex at least some of the N streams of the N-stream multi-view 3D video into one pseudo 2D stream, appearing as a 2D video stream to a 2D video encoder. The functional unit is further adapted to provide the pseudo 2D stream to a replaceable 2D encoder, for encoding of the pseudo 2D stream, resulting in encoded data having a 2D codec format.

According to a third aspect, a method is provided for de-compressing N-stream multi-view 3D video is provided in a video handling, or video presenting, entity. The method comprises obtaining data for de-compression and determining a 2D codec format of any obtained 2D-encoded N-stream multi-view 3D video data. The method further comprises providing the obtained data to a replaceable 2D decoder supporting the determined 2D format, for decoding of the obtained data, resulting in a pseudo 2D video stream. The method further comprises de-multiplexing of the pseudo 2D video stream into the separate streams of the N-stream multi-view 3D video, comprised in the obtained data.

According to a fourth aspect, an arrangement adapted to de-compress N-stream multi-view 3D video is provided in a video handling, or video presenting, entity. The arrangement comprises a functional unit, which is adapted to obtain data for de-compression. The arrangement further comprises a functional unit, which is adapted to determine a 2D encoding format of obtained 2D-encoded N-stream multi-view 3D video data; and is further adapted to provide said obtained data to a replaceable 2D decoder supporting the determined 2D format, for decoding of the obtained data. The decoding resulting in a pseudo 2D video stream. The arrangement further comprises a functional unit, which is adapted to de-multiplex the pseudo 2D video stream into the separate streams of the N-stream multi-view 3D video, comprised in the obtained data.

The above methods and arrangements enable compression and de-compression of N-stream multi-view 3D video in a codec-agnostic manner. By use of the above methods and arrangements, state-or-the art compression technology developed for 2D video compression could immediately be taken advantage of for 3D functionality purposes. No or little standardization is necessary to use a new 2D codec in a 3D scenario. This way the lead time for 3D codec technology will be reduced and kept on par with 2D video codec development and standardization. Further, the described approach is not only applicable to, or intended for, stereo 3D video, but is very flexible and easily scales up to simultaneously compressing more than two views, which is a great advantage over the prior art.

The above methods and arrangements may be implemented in different embodiments. In some embodiments, the encoded data, having a 2D codec format, is encapsulated in a data format indicating encoded 3D video before being transferred to e.g. another data handling entity. This ensures that only a receiver which is capable of handling such encapsulated 3D data will attempt to decode and display the data. The compressed encoded and possibly encapsulated data may be provided, e.g. transferred or transmitted, to a storage unit, such as a memory, or to an entity which is to de-compress the data. The multi-view 3D data could be compressed and de-compressed within the same entity or node.

In some embodiments, metadata related to the multiplexing of the multi-view 3D video is provided to a receiver of the encoded data, at least partly, in association with the encoded data. Information on the multiplexing scheme used could also, at least partly, e.g. be transferred implicitly, or be pre-agreed. In any case, the entity which is to de-compress the compressed data should have access to or be provided with information on the multiplexing scheme used when compressing the data.

Other information, such as depth information; disparity information occlusion information; segmentation information and/or transparency information, could be multiplexed into the pseudo 2D stream together with the video streams. This feature enables a very convenient handling of supplemental information.

The different features of the exemplary embodiments above may be combined in different ways according to need, requirements or preference.

The above exemplary embodiments have basically been described in terms of a method for compressing multi-view 3D video. However, the described arrangement for compressing multi-view 3D video has corresponding embodiments where the different units are adapted to carry out the above described method embodiments. Further, corresponding embodiments for a method and arrangement for de-compression of compressed multi-view 3D video are also disclosed.

### BRIEF DESCRIPTION OF THE DRAWINGS

The invention will now be described in more detail by means of exemplary embodiments and with reference to the accompanying drawings, in which:

FIG. 1 is a schematic view illustrating the time-aspect of development of new codec standards, according to the prior art.

FIG. 2 is a schematic view illustrating the time-aspect of development of new codec standards when applying embodiments of the invention.

FIGS. 3-5 are schematic views illustrating multiplexing and de-multiplexing of N-stream multi-view 3D video.

FIGS. 6a-c are schematic views illustrating the displayed result of using different signalling approaches in combination with different decoding arrangements.

FIG. 7 is a schematic view illustrating de-multiplexing of N-stream multi-view 3D video.

FIG. 8 is a flow chart illustrating a procedure for 3D video compression in a video handling, or video providing, entity, according to an example embodiment.

FIG. 9 is a block diagram illustrating an arrangement adapted for 3D video compression in a video handling, or video providing, entity, according to an example embodiment.

FIG. 10 is a flow chart illustrating a procedure for 3D video de-compression in a video handling, or video presenting, entity, according to an example embodiment.

FIG. 11 is a block diagram illustrating an arrangement adapted for 3D video de-compression in a video handling, or video presenting, entity, according to an example embodiment.

FIG. 12 is a block diagram illustrating an arrangement adapted for 3D video de-compression in a video handling, or video presenting, entity, according to an example embodiment.

FIG. 13 is a schematic view illustrating an arrangement in a video handling entity, according to an embodiment.

### DETAILED DESCRIPTION

Briefly described, a modular approach to enabling standard compliant 3D video compression and de-compression is provided, in which both existing video codecs, and video compression schemes yet to be defined, may be utilized. This is basically achieved by separating compression schemes, which are common to 2D encoding, such as e.g. predictive macro block encoding, from that which is specific to 3D, and thus making N-stream multi-view 3D video compression codec-agnostic, i.e. not dependent on a certain codec or exclusively integrated with a certain codec.

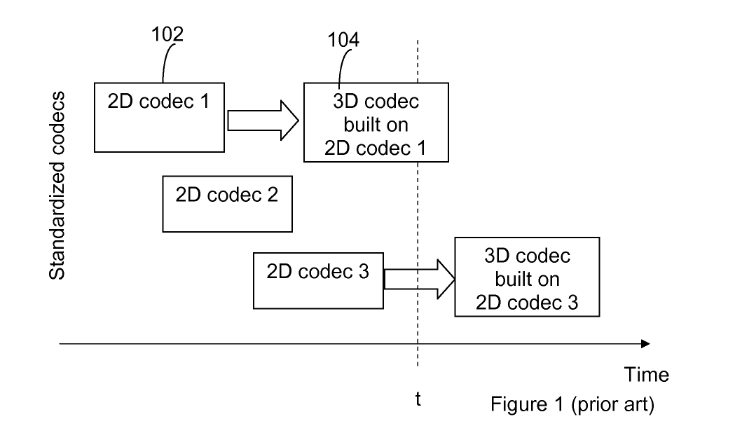

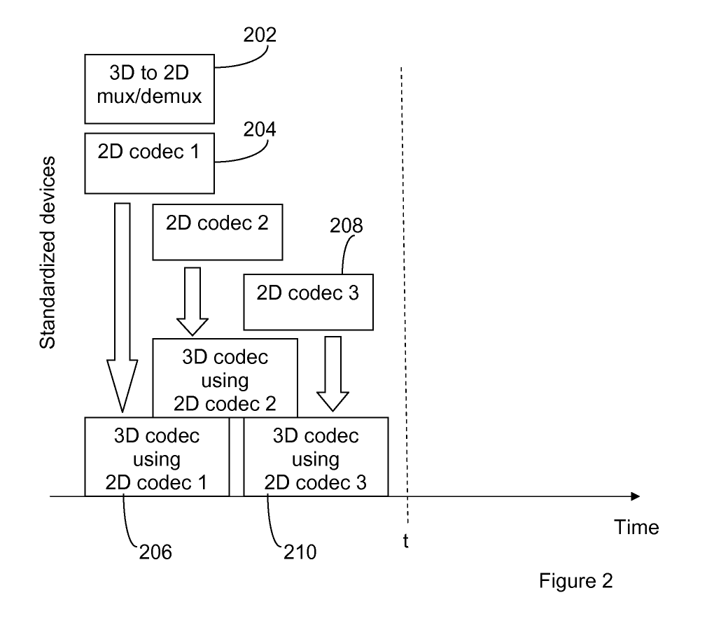

This modular approach enables a fast“development” of multi-view 3D codecs based on already existing or very recently developed 2D codecs. An example of such a scenario is illustrated in a time perspective in FIG. 2. FIG. 2 should be studied in comparison with FIG. 1, which illustrates the scenario of today. When having access to a device 202, which may be standardized, which consolidates multiple streams of N-stream multi-view 3D video into a pseudo 2D stream, this pseudo 2D stream could be encoded with practically any available standard compliant 2D encoder. In FIG. 2, this is illustrated e.g. as 3D codec 206, which is formed by a combination of 3D-to-2D mux/demux 202 and 2D codec 1 204. Ata later point in time, 3D-to-2D mux/demux 202 could instead be used together with, e.g. recently standardized, 2D codec 3 208, and thus form 3D codec 210.

When developing a customized 3D codec from a certain 2D codec, e.g. as illustrated in FIG. 1, where 3D codec 104 is developed from 2D codec 102, this customized 3D codec could, of course, be optimized to the certain 2D codec from which it is developed. This could mean that the 3D codec 104 is faster or better in some other aspect, as compared to the 3D codec 206 in FIG. 2, using the same 2D encoder. The great advantage of 3D codec 206, however, is the point in time when it is ready to use, which is long before 3D codec 104 in FIG. 1. By the time 3D codec 104 is ready to use, 3D codec 210 in FIG. 2 is already available, as a consequence of the standardization of 2D codec 3 208. The 3D codec 210 in FIG. 2, in its turn, may provide better compression, be faster, or better in some other aspect, than 3D codec 104 in FIG. 1.

Within this document, some expressions will be used when discussing the procedure of compressing video, some of which will be briefly defined here.

The term “3D ” is used as meaning 3-dimensional, i.e. having 3 dimensions. In terms of video, this can be achieved by N-stream video, where N=2, enabling the video to be perceived by a viewer as having the 3 dimensions: width, height and depth, when being appropriately displayed to said viewer. Availability of “depth” as the third dimension after width and height, may also allow the viewer to “look around” displayed objects as she/he moves around in front of the display. This feature is called “free-view” and can be e.g. realized by so-called auto stereoscopic multi-view displays.

The term 2D is used as meaning 2-dimensional, i.e. having 2 dimensions. In terms of video, this means 1-stream video, enabling the video to be perceived by a viewer as having the 2 dimensions: width and height, when being appropriately displayed to said viewer.

The term “pseudo 2D ” in contexts such as “pseudo 2D video stream”, is used as referring to a stream which appears to be a stream of 2D video to a 2D codec, but in fact is a stream of 3D video comprising multiple multiplexed, e.g. interleaved, streams.

The term “3D bucket format” is used as referring to a certain data format indicating to a receiver of said data, which is able to recognize said format, that the received data comprises 3D video, which is compressed using a 2D codec. The 3D bucket format could also be called a “3D video formal”, a “data format indicating 3D video”, or a “3D video codec format”.

The term “codec” is used in its conventional meaning, i.e. as referring to an encoder and/or decoder.

The term “video handling entity” is used as referring to an entity, or node, in which it is desirable to compress or de-compress multi-view 3D video. An entity, in which 3D video can be compressed, can also be denoted “video providing entity”. An entity, in which compressed 3D video can be de-compressed, can also be denoted “video presenting entity”. A video handling entity may be either one or both of a video providing entity and a video presenting entity, either simultaneously or at different occasions.

The 3D compression approach described herein may utilize the three main concepts of 3D compression, which are:
1) Multi-view video compression: Here, multiple, i.e. two or more, views are encoded together, utilizing intra and inter stream redundancies, into one or more bit streams. Multi-view video compression may be applied to conventional multi-view video data as captured from multiple view points. Additionally, it may be applied to additional or “extra” information that aids in view synthesis, such as depth maps (see 2, below).
2) View synthesis: Apart from the actual coding and decoding of views, novel views can be synthesized using view synthesis. In addition to neighboring views, additional or “extra” information is given which helps with the synthesis of novel views. Examples of such information are depth maps, disparity maps, occlusion information, segmentation information and transparency information. This extra information may also be referred to as metadata, similarly to the metadata described in 3) below.
3) Metadata: Finally, metadata, such as information about camera location, clipping planes, etc., may be provided. The metadata may also comprise e.g. information about which encoding/decoding modules that are used in the multi-view compression, such as to e.g. indicate to the receiver which decoding module to use for decompression of the multi-view videos.

Conventionally, multi-view video compression has been defined as to provide compression of multiple views using a suitable 3D codec, e.g. an MVC codec. Within this disclosure, a new multi-view video compression approach is suggested, which uses a replaceable codec. Henceforth, within this disclosure, multi-view video compression refers to a mechanism for arranging or “ordering” frames from one or more views into one or more sequences of frames, i.e. multiplexing a plurality of views, and inputting these frames into a replaceable encoding module. A reversed process is to be performed on the decoding side. The replaceable codecs used, i.e., the encoding and decoding modules, should not be necessary to adapt or modify for the purpose of functioning in this new multi-view video compression approach.

Further, one or more of depth map streams, disparity maps streams, occlusion information streams, segmentation information streams, and transparency information streams may be arranged or “ordered” into, i.e. multiplexed with, one or more sequences of frames, and input into the encoding module. In some embodiments, depth map or other metadata frames and video frames may be arranged in the same sequence of frames, i.e. be multiplexed together, for encoding in a first encoding module. Depth map streams, disparity streams, occlusion streams etc. may also be encoded by a separate encoding module that either follows the same specification as the first encoder module, or another encoding module that follows another specification. Both the encoder modules for views and e.g. depth maps may be replaceable. For instance, the video views may be coded according to a video codec such as H.264/AVC, whereas segmentation information may be coded according to a codec that is particularly suitable for this kind of data, e.g. a binary image codec.

In some embodiments, pixels, or groups of pixels, such as macro blocks, may be arranged into frames which then are input into an encoding module.

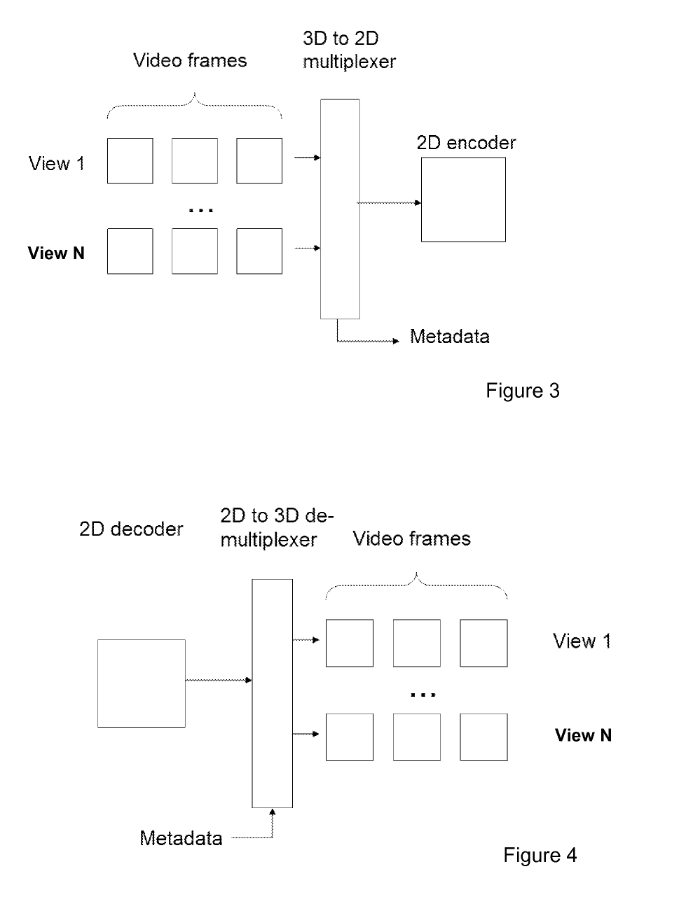

### Example Arrangement/Procedure, FIG. 3, Encoding

An example embodiment of a multi-view 3D video compression arrangement is schematically illustrated in FIG. 3. In this embodiment, multiple views, or streams, of 3D video are reorganized into a single, pseudo 2D, video stream on a frame-by-frame basis.

The encoding process may comprise both encoding of conventional video views as captured from multiple view point, and/or encoding of additional or “extra” information, such as e.g. depth information, which may be used in the view synthesis process.

The corresponding encoding arrangement comprises the following individual or “separate” components:
1) 3D to 2D multiplexer
2) 2D encoder

The 3D to 2D multiplexer takes multiple views, and possibly metadata such as depth map frames, disparity map frames, occlusion frames or alike, as input, and provides a single stream of frames as output, which is used as input to the 2D encoder. The choice of actual rearranging scheme, or multiplexing scheme, used is not limited to the examples in this disclosure, but information concerning the rearranging scheme used should be provided to the decoder, either explicitly, e.g. as metadata, or implicitly. A simple example of multiplexing two synchronized streams of stereo views is to form a single 2D stream with temporally interleaved views, e.g., first encode view 1 (“left”) for a particular point in time, then view 2 (“right”) for the same point in time, then repeat with the view pair for the next point in time, More advanced multiplexing schemes can be used to form the new pseudo 2D stream by an arbitrary rearrangement of frames from different views and times.

As explained earlier, the 2D encoder is intended to be a completely 2D-standard-compliant video encoder, and thus be replaceable for any other 2D-standard-compliant video encoder. The 2D encoder need not know that the input is in fact multiplexed 3D data. In some embodiment the 2D encoder can be set up in a way that is specifically suited for this purpose. An example of this is the marking of reference pictures and frames which are to be used as reference. The marking of reference pictures and frames indicates to the 2D encoder which pictures and frames it should consider using as reference picture or frames e.g. for intra view prediction or inter-view prediction. This indication can be derived according to 3D-to-2D multiplexing. If for instance, the multiplexed stream consists of three different video views, in a periodic order picture of stream 1, then picture of stream 2, then picture of stream 3, it could be indicated to the encoder that e.g. every third picture could be beneficially used as reference for intra-stream prediction, i.e. a picture of stream 1 is predicted from another picture of stream 1 etc. It should be noted that this does not affect the standard compliance of the encoder or the decodability of the stream by a standard decoder.

### Example Arrangement/Procedure, FIG. 4, Decoding

An example embodiment of an N-stream multi-view 3D video de-compression arrangement is schematically illustrated in FIG. 4. The decoding process is the reverse of the corresponding encoding process. Firstly, video frames are decoded and input as a single stream to the 2D to 3D de-multiplexer, together with e.g. metadata and/or implicit information regarding the multiplexing scheme used. The de-multiplexer rearranges the stream into the original N views, which then may be displayed.

In accordance with the encoding process, the decoding process may comprise both decoding of conventional video views as captured from multiple view points, and/or decoding of extra information, such as depth information, which may be used in the view synthesis process.

The 3D to 2D multiplexer and the 2D to 3D de-multiplexer may work on a pixel level, or a group of pixels level, or on a frame level, as in the previously described embodiment An example of multiplexing multiple views on a pixel level is to arrange the pixels of two or more frames into a single frame, e.g. side-by-side, as illustrated in FIG. 5. Yet another example is to arrange the pixels from two views into a checkerboard style configuration, or to interleave frames line by line. The frame size need not be the same for the pseudo 2D stream as for the streams comprised in the pseudo 2D stream

The de-compression process will be the reverse of the corresponding compression process. Firstly, video frames are decoded and input as a single stream to the 2D to 3D de-multiplexer. The de-multiplexer, using side information regarding the multiplexing scheme used during compression, provided e.g. as metadata and/or implicit information, rearranges the stream, at pixel level, into the original number of compressed views.

The data to be processed may, as previously mentioned, be conventional video data as captured from multiple view points, and/or extra information to be used e.g. in view synthesis, such as depth data, disparity data, occlusion data, segmentation data, transparency data, or alike.

### Transport And Signaling

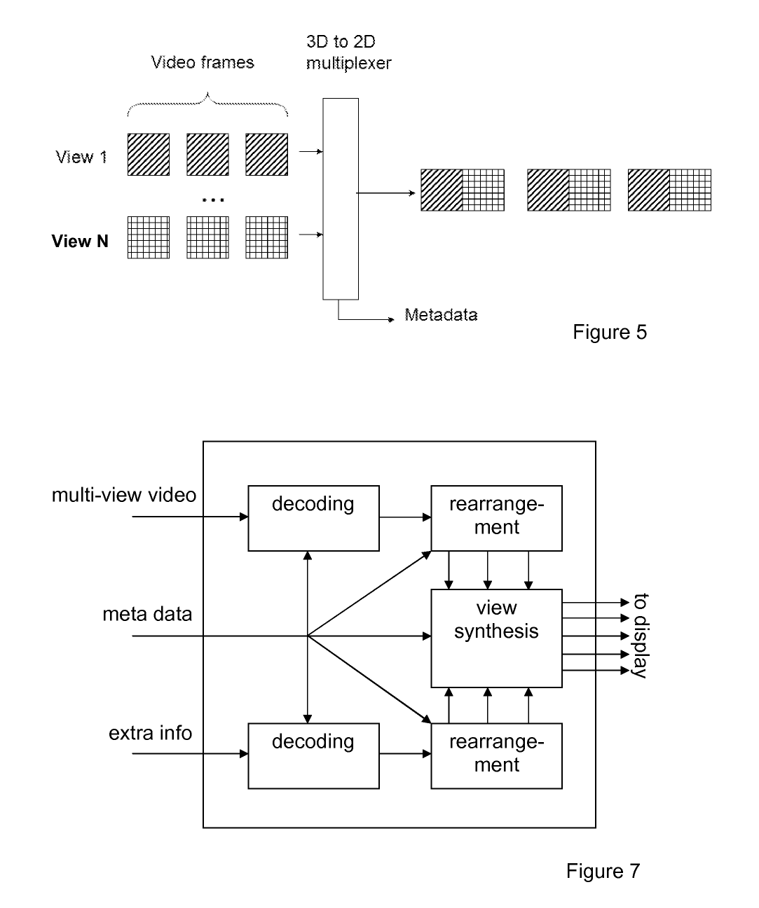

It has previously been mentioned that metadata may be used to signal or indicate that a bit stream is in fact a 3D bit stream, and not a 2D bit stream. However, the consequence of using side information, such as metadata, for indicating 3D video, may be that a simple 2D decoder, a legacy 2D decoder and/or video handling entity, which does not understand the side information or the concept of such metadata, may mistake a 3D bit stream for a true 2D bit stream. Mistaking a 3D video stream, in a “2D guise”, for a true 2D video stream will result in annoying flickering when displaying the decoded stream. This is schematically illustrated in FIG. 6a. Such misunderstandings may be avoided as follows:

### 3D Data Format

An N-stream multi-view 3D video, which has been multiplexed into a pseudo 2D stream and which has been encoded using a standard compliant 2D encoder, may be transported or signaled as a new type of 3D data format, or 3D video codec format. This new 3D data format would then “contain” the codec formats of the different components, such as the conventional video data and depth data, which are then “hidden behind” the 3D data format. Such a data format encapsulating another format may be referred to as a “bucket” format. The advantage of using such a format is that a simple 2D decoder, without 3D capability, will not attempt to decode the bit stream when signaled within the 3D data format, since it will not recognize the format. This is illustrated in FIG. 6b.

However, when applying embodiments of the invention involving the 3D data format, a pseudo 2D stream transported within or “hidden behind” the 3D data format, will be interpreted correctly, and thus enabling appropriate displaying of the 3D video, as illustrated in FIG. 6c. For instance, in the case the encoded 3D data format comprises a sequence of compressed 3D video packets, each “3D video packet” may contain header information that indicates it as a “3D video packet”, however inside the packet, data, i.e. one or multiple streams, or part thereof, may be carried in a format that complies with a 2D data format. Since a simple 2D decoder may first inspect the header of a packet, and since that indicates the stream as “3D data”, it will not attempt to decode it. Alternatively, the encoded 3D data format may actually consist of a sequence of video packets that comply with a 2D data format, but additional information outside the 3D data stream, e.g. signaling in a file header in case of file storage, or signaling in an SDP (session description protocol) may indicate that the data complies with a 3D data format.

In some embodiments, the video codec format may be signaled the same way as when transporting actual 2D video, but accompanied by supplementary information regarding 3D, and/or with measures taken related to 3D. One example, when the streams of the different views are multiplexed by interleaving on a frame level, is to let the frames in the multiplexed stream corresponding to one particular view, a first view, be recognizable to legacy 2D decoders, or video handling entities, but let the other views, e.g. a second, third and further views, only be recognizable to 3D-aware arrangements, video handling entities or codecs.

This could be accomplished by marking, after 2D encoding, those parts of the encoded video that represent frames of the second, third, and further views in a different way than those parts of the encoded video that represent frames of the first view, thereby enabling a receiver to distinguish the first view from the other views and/or data. In particular, the part of the encoded video that represent the second, third and further views could be marked in a way such that according to the specification of the 2D video decoder, they will be ignored by such 2D decoder. For instance, in case of H.264/AVC, those part of the stream that represent frames of the first view could be marked with a NAL (network abstraction layer) unit header that indicates a valid NALunit according to H.264/AVC specifications, and those part of the stream that represent frames of other views could be marked with NAL unit headers that must be ignored by compliant H.264/AVC decoders (those are specified in the H.264/AVC standard). However those NALunit headers that must be ignored by compliant H.264/AVC decoders could be understood by 3D-aware arrangements, and processed accordingly. Alternatively, e.g. in case of transporting the data (e.g. using RTP, real-time transport protocol), the part of the encoded video that represents frames of a second, third and further view could be transported over a different transport channel (e.g. in a different RTP session) than the part of the encoded video that represent frames of the first view, and a 2D video device would only receive data from the transport channel that transport the encoded video that represents frames of the first view, whereas a 3D device would receive data from both transport channels. This way, the same stream would be correctly rendered by both 2D video and 3D video devices.

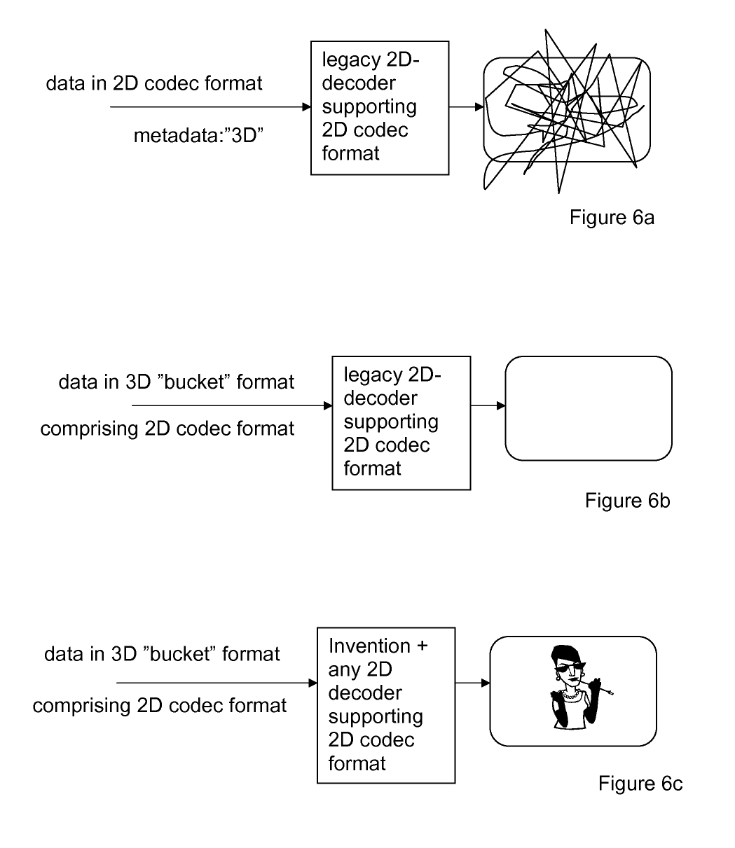

### Exemplary Embodiment, FIG. 7

FIG. 7 shows an example embodiment of an arrangement for 3D de-compression. Input used in the example arrangement includes multi-view video, i.e. multiple camera views coded together, extra information, such as depth information for view synthesis; and metadata. The multi-view video is decoded using a conventional 2D video decoder, which is selected according to the signaling in the meta information. The decoded video frames are then re-arranged into the separate multiple views comprised in the input multi-view video, in a 2D-to-3D multiplexer. The extra information is also decoded, using a conventional 2D video decoder, as signaled in the metadata, and re-arranged as signaled in the metadata. Both the decoded and re-arranged multi-view video and extra information are fed into the view synthesis, which creates a number of views as required. The synthesized views are then sent to a display. Alternatively, the view synthesis module may be controlled based on user input, to synthesize e.g. only one view, as requested by a user. The availability of multiple views and potentially metadata such as depth data, disparity data, occlusion data, transparency data, could be signaled in a signaling section of the 3D data stream, e.g. a 3D SEI (supplemental enhancement information) message in case of H.264/AVC, or a 3D header section in a file in case of file storage. Such SEI or header sections could indicate to the 3D decoder which components are carried in the 3D data stream, and how they can be identified, e.g. by parsing and interpreting video packet headers, NALunit headers, RTP headers, or alike.

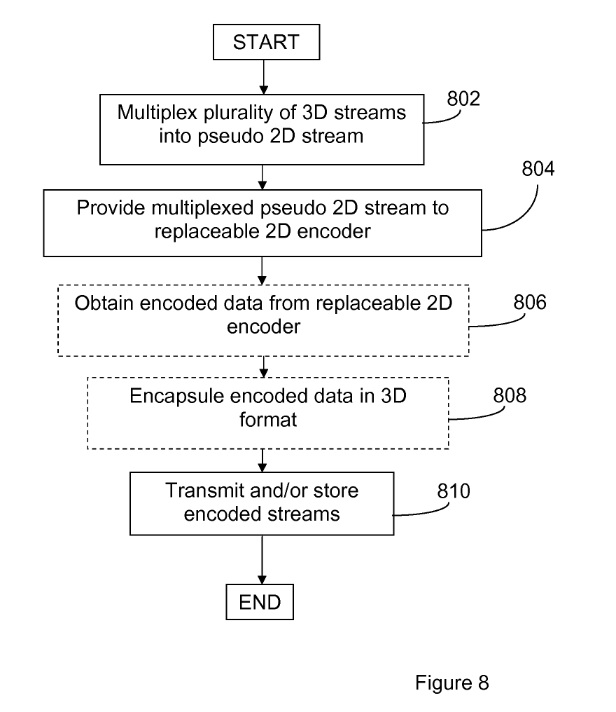

### Exemplary Procedure, FIG. 8, Compression

An embodiment of the procedure of compressing N-stream multi-view 3D video using practically any available 2D video encoder, will now be described with reference to FIG. 8. The procedure could be performed in a video handling entity, which could be denoted a video providing entity. Initially, a plurality of the N streams of 3D video is multiplexed into a pseudo 2D video stream in an action 802. The plurality of video streams may e.g. be received from a number of cameras or a camera array. The 2D video stream is then provided to a replaceable 2D video encoder in an action 804. The fact that the 2D video encoder is replaceable, i.e. that the part of the compressing arrangement which is specific to 3D is independent of the codec used, is a great advantage, since it enables the use of practically any available 2D video codec. The 2D codec could be updated at any time, e.g. to the currently best existing 2D video codec, or to a preferred 2D video codec at hand. For example, when a new efficient 2D video codec has been developed and is available, e.g. on the market or free to download, the “old” 2D video codec used for the compression of 3D data could be exchanged for the new more efficient one, without having to adapt the new codec to the purpose of compressing 3D video.

After encoding, the encoded pseudo 2D video stream may be obtained from the replaceable 2D video encoder in an action 806, e.g. for further processing. An example of such further processing is encapsulation of the encoded pseudo 2D video stream into a data format indicating, e.g. to a receiver of the encapsulated data, that the stream comprises compressed 3D video. This further processing could be performed in an optional action 808, illustrated with a dashed outline. The output from the replaceable 2D video encoder may, with or without further processing, be transmitted or provided e.g. to another node or entity and/or to a storage facility or unit, in an action 810.

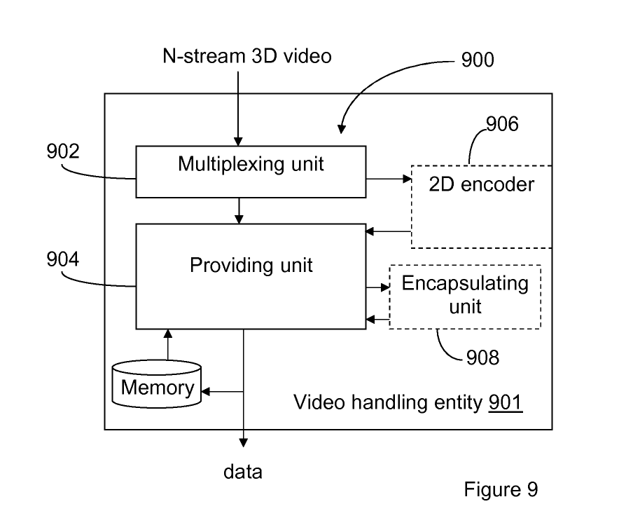

### Example Arrangement, FIG. 9, Compression

Below, an exemplary arrangement 900, adapted to enable the performance of the above described procedure of compressing N-stream multi-view 3D video, will be described with reference to FIG. 9. The arrangement is illustrated as being located in a video handling, or video providing, entity, 901, which could be e.g. a computer, a mobile terminal or a video-dedicated device. The arrangement 900 comprises a multiplexing unit 902, adapted to multiplex at least some of the N streams of the N-stream multi-view 3D video into one pseudo 2D stream. The plurality of video streams may e.g. be received from a plurality of cameras or a camera array. The multiplexing unit 902 is further adapted to provide the pseudo 2D stream to a replaceable 2D encoder 906, for encoding of the pseudo 2D stream, resulting in encoded data. The multiplexing unit 902 may further be adapted to produce, or provide, metadata related to the multiplexing of the multi-view 3D video, e.g. an indication of which multiplexing scheme that is used.

The arrangement 900 may further comprise a providing unit 904, adapted to obtain the encoded data from the replaceable 2D video encoder 906, and provide said encoded data e.g. to a video handling entity for de-compression, and/or to an internal or external memory or storage unit, for storage. The arrangement 900 may also comprise an optional encapsulating unit 908, for further processing of the encoded data. The providing unit 904 may further be adapted to provide the encoded data to the encapsulating unit 908, e.g. before providing the data to a storage unit or before transmitting the encoded data to a video handling entity. The encapsulating unit 908 may be adapted to encapsulate the encoded data, which has a format dependent on the 2D video encoder, in a data format indicating encoded 3D video.

### Information On the Multiplexing Scheme

Information on how the different streams of 3D video are multiplexed during compression, i.e. the currently used multiplexing scheme, must be provided, e.g. to a receiver of the compressed 3D video, in order to enable proper de-compression of the compressed video streams. For example, in terms of the arrangement illustrated in FIG. 9, this information could be produced and/or provided by the multiplexing unit 902. The information on the multiplexing could be signaled or stored e.g. together with the compressed 3D video data, or in association with the same. Signaling could be stored e.g. in a header information section in a file, such as in a specific “3D box” in an MPEG-4 file or signaled in a H.264/AVC SEI message.

The information on the multiplexing could also e.g. be signaled before or after the compressed video, possibly via so called “out-of-band signaling”, i.e. on a different communication channel than the one used for the actual compressed video. An example for such out-of-band signaling is SDP (session description protocol). Alternatively, the multiplexing scheme could be e.g. negotiated between nodes, pre-agreed or standardized, and thus be known to a de-compressing entity. Information on the multiplexing scheme could be communicated or conveyed to a de-compressing entity either explicitly or implicitly. The information on the multiplexing scheme should not be confused with the other 3D related metadata, or extra info, which also may be accompanying the compressed 3D streams, such as e.g. depth information and disparity data for view synthesis, and 2D codec-related information.

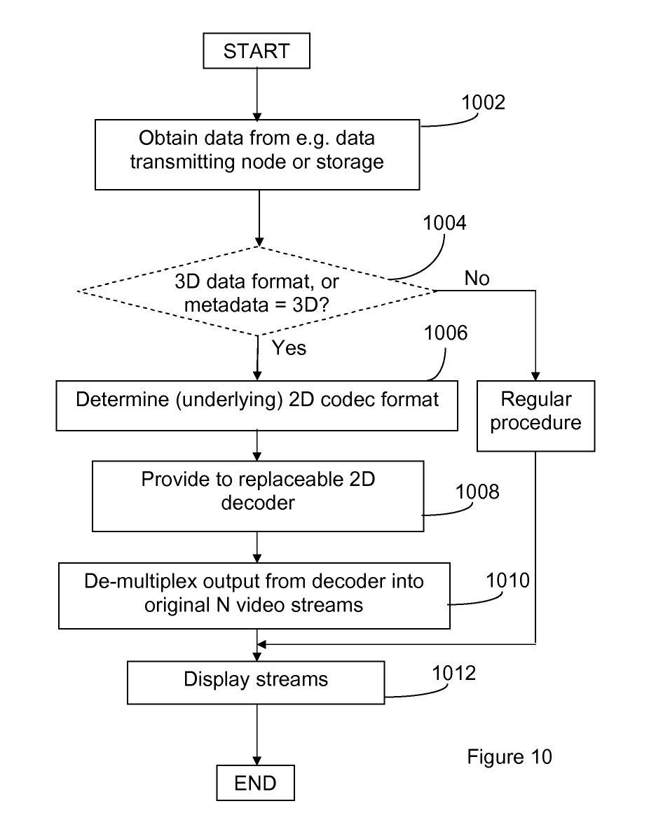

### Exemplary Procedure, FIG. 10, De-Compression

An embodiment of the procedure of de-compressing N-stream multi-view 3D video will now be described with reference to FIG. 10. The procedure could be performed in a video handling entity, which could be denoted a video presenting entity. Initially, data for de-compression, i.e. data to be de-compressed and any associated information, is obtained in an action 1002. The data could be e.g. received from a data transmitting node, e.g. a video handling or video providing entity, or be retrieved from storage, e.g. an internal storage unit, such as a memory

The procedure may further comprise an action 1004, wherein it may be determined whether the obtained data comprises compressed 2D-encoded N-stream multi-view 3D video. For example, it could be determined if the obtained data has a data format, e.g. is encapsulated in such a data format, indicating encoded 3D video, and/or be determined if the obtained data is accompanied by metadata indicating encoded 3D video, and thus comprises 2D-encoded N-stream multi-view 3D video having a 2D codec format. At least in the case when the 2D-encoded data is encapsulated in a data format indicating encoded 3D video, the 2D codec format could be referred to as an “underlying format” to the data format indicating encoded 3D video.

The, possibly “underlying”, 2D video codec format of the obtained data is determined in an action 1006. The 2D video codec format indicates which type of 2D codec that was used for encoding the data. The obtained data is then provided to a replaceable 2D video decoder, supporting the determined 2D video codec format, in an action 1008. The decoding in the replaceable decoder should result in a pseudo 2D video stream.

The pseudo 2D video stream is de-multiplexed in an action 1010, into the separate streams of the N-stream multi-view 3D video, comprised in the obtained data. The action 1010 requires knowledge of how the separate streams of the N-stream multi-view 3D video, comprised in the obtained data, were multiplexed during 3D video compression. This knowledge or information could be provided in a number of different ways, e.g. as metadata associated with the compressed data, as previously described.

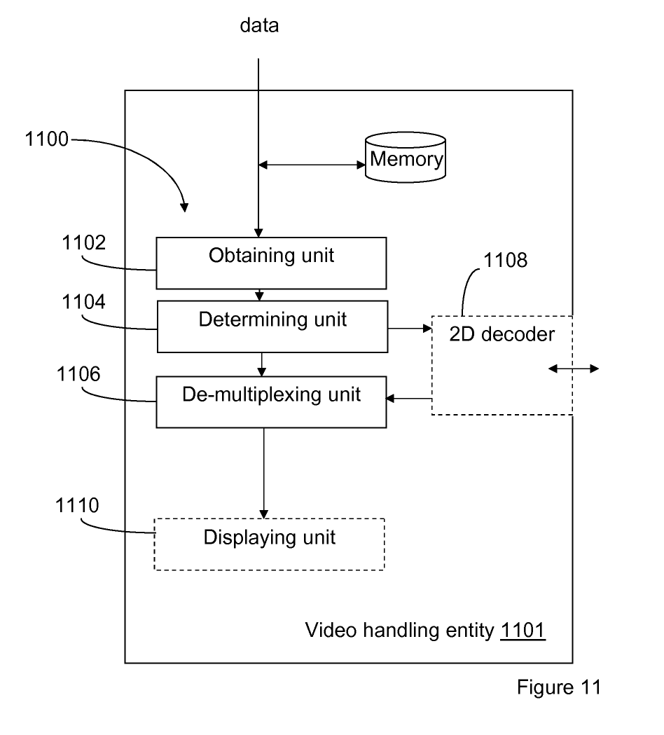

### Example Arrangement, FIG. 11, De-Compression

Below, an exemplary arrangement 1100, adapted to enable the performance of the above described procedure of de-compressing compressed N-stream multi-view 3D video, will be described with reference to FIG. 11. The arrangement is illustrated as residing in a video handling, or video presenting, entity 1101, which could be e.g. a computer, a mobile terminal or a video-dedicated device. The video handling or providing entity 901 described in conjunction with FIG. 9 and the video handling, or presenting, entity 1101 may be the same entity or different entities. The arrangement 1100 comprises an obtaining unit 1102, adapted to obtain data for de-compression and any associated information. The data could e.g. be received from a data transmitting node, such as another video handling/providing entity, or be retrieved from storage, e.g. an internal storage unit, such as a memory.

The arrangement 1100 further comprises a determining unit 1104, adapted to determine a 2D encoding, or codec, format of obtained 2D-encoded N-stream multi-view 3D video data. The determining unit 1104 could also be adapted to determine whether the obtained data comprises 2D-encoded N-stream multi-view 3D video, e.g. by analyzing the data format of the obtained data and/or by analyzing the metadata associated with the obtained data. The metadata may be related to 3D video in a way indicating comprised 2D-encoded N-stream multi-view 3D video, and/or the format of the obtained data may be of a type, which indicates, e.g. according to predetermined rules or instructions provided by a control node or similar, that the obtained data comprises 2D-encoded N-stream multi-view 3D video.

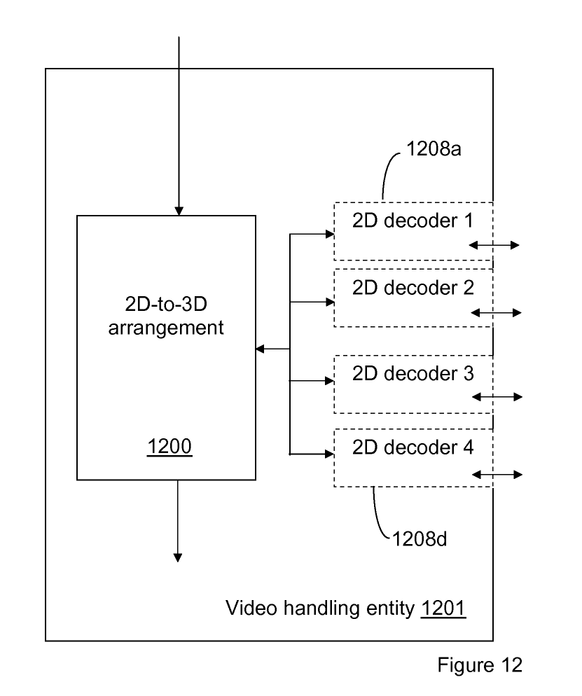

The determining unit 1104 is further adapted to provide the obtained data to a replaceable 2D decoder 1108, which supports the determined 2D codec format, for decoding of the obtained data, resulting in a pseudo 2D video stream. The fact that the 2D codec is replaceable or exchangeable is illustrated in FIG. 11 by a two-way arrow, and that the outline of the codec is dashed. Further, there could be a number of different 2D-codecs available for decoding, which support different format, and thus may match the 2D codec used on the compression side. Such an embodiment is illustrated in FIG. 12, where the arrangement 1200 is adapted to determine which 2D decoder of the 2D codecs 1208a-d that is suitable for decoding a certain received stream. The replaceability of the codecs 1208a-d is illustrated by a respective two-way arrow. Similarly, there may also be a plurality of 2D encoders available for data compression in a video compressing entity, e.g. for having alternatives when it is known that a receiver or a group of receivers of compressed video do not have access to certain types of codecs.

The arrangement 1100 further comprises a de-multiplexing unit 1106, adapted to de-multiplex the pseudo 2D video stream into the separate streams of the N-stream multi-view 3D video, comprised in the obtained data. The de-multiplexing unit 1106 should be provided with information on how the separate streams of the N-stream multi-view 3D video, comprised in the obtained data, were multiplexed during 3D video compression, i.e. of the multiplexing scheme. This information could be provided in a number of different ways, e.g. as metadata associated with the compressed data or be predetermined, as previously described. The multiple streams of multi-view 3D video could then be provided to a displaying unit 1110, which could be comprised in the video handling, or presenting, entity, or, be external to the same.

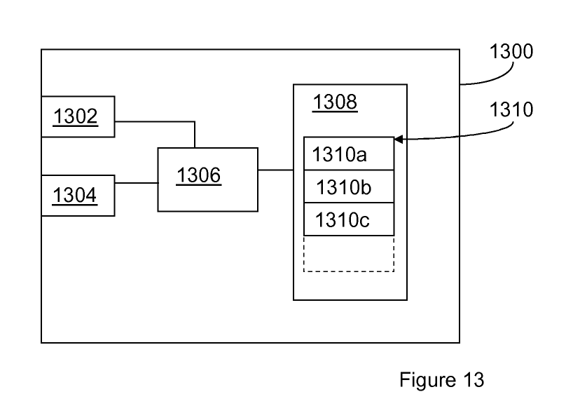

### Example Arrangement, FIG. 13

FIG. 13 schematically shows an embodiment of an arrangement 1300 in a video handling or video presenting entity, which also can be an alternative way of disclosing an embodiment of the arrangement for de-compression in a video handling/presenting entity illustrated in FIG. 11. Comprised in the arrangement 1300 are here a processing unit 1306, e.g. with a DSP (Digital Signal Processor) and an encoding and a decoding module. The processing unit 1306 can be a single unit or a plurality of unit to perform different actions of procedures described herein. The arrangement 1300 may also comprise an input unit 1302 for receiving signals from other entities, and an output unit 1304 for providing signal(s) to other entities. The input unit 1302 and the output unit 1304 may be arranged as an integrated entity.

Furthermore, the arrangement 1300 comprises at least one computer program product 1308 in the form of a non-volatile memory, e.g. an EEPROM (Electrically Erasable Programmable Read-Only Memory), a flash memory and a disk drive. The computer program product 1308 comprises a computer program 1310, which comprises code means, which when run in the processing unit 1306 in the arrangement 1300 causes the arrangement and/or the video handling/presenting entity to perform the actions of the procedures described earlier in conjunction with FIG. 10.

The computer program 1310 may be configured as a computer program code structured in computer program modules. Hence in the exemplary embodiments described, the code means in the computer program 1310 of the arrangement 1300 comprises an obtaining module 1310a for obtaining data, e.g., receiving data from a data transmitting entity or retrieving data from storage, e.g. in a memory. The computer program further comprises a determining module 1310b for determining a 2D encoding or codec format of obtained 2D-encoded N-stream multi-view 3D video data. The determining module 1310b further provides the obtained data to a replaceable 2D decoder, which supports the determined 2D codec format, for decoding of the obtained data, resulting in a pseudo 2D video stream. The 2D decoder may or may not be comprised as a module in the computer program. The 2D decoder may be one of a plurality of available decoders, and be implemented in hardware and/or software, and may be implemented as a plug-in, which easily can be exchanged and replaced for another 2D-decoder. The computer program 1310 further comprises a de-multiplexing module 1310c for de-multiplexing the pseudo 2D video stream into the separate streams of the N-stream multi-view 3D video, comprised in the obtained data.

The modules 1310a-c could essentially perform the actions of the flows illustrated in FIG. 10, to emulate the arrangement in a video handling/presenting entity illustrated in FIG. 11. In other words, when the different modules 1310a-c are run on the processing unit 1306, they correspond to the unit 1102-1106 of FIG. 11.

Similarly, corresponding alternatives to the respective arrangement illustrated in FIGS. 7 and 9, are possible.

Although the code means in the embodiment disclosed above in conjunction with FIG. 13 are implemented as computer program modules which when run on the processing unit causes the arrangement and/or video handling/presenting entity to perform the actions described above in the conjunction with figures mentioned above, at least one of the code means may in alternative embodiments be implemented at least partly as hardware circuits.

The processor may be a single CPU (Central processing unit), but could also comprise two or more processing unit. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product comprises a computer readable medium on which the computer program is stored. For example, the computer program product may be a flash memory, a RAM (Random-access memory) ROM (Read-Only Memory) or an EEPROM (Electrically Erasable Programmable ROM), and the computer program modules described above could in alternative embodiments be distributed on different computer program product in the form of memories within the data receiving unit.

While the procedure as suggested above has been described with reference to specific embodiments provided as examples, the description is generally only intended to illustrate the inventive concept and should not be taken as limiting the scope of the suggested methods and arrangements, which are defined by the appended claims. While described in general terms, the methods and arrangements may be applicable e.g. for different types of communication systems, using commonly available communication technologies, such as e.g. GSM/EDGE, WCDMA or LTE or broadcast technologies over satellite, terrestrial, or cable e.g. DVB-S, DVB-T, or DVB-C.

It is also to be understood that the choice of interacting units or modules, as well as the naming of the units are only for exemplifying purpose, and video handling entities suitable to execute any of the methods described above may be configured in a plurality of alternative ways in order to be able to execute the suggested process actions.

It should also be noted that the units or modules described in this disclosure are to be regarded as logical entities and not with necessity as separate physical entities.

### REFERENCES

[1] ITU-T Recommendation H.264 (03/09): “Advanced video coding for generic audiovisual services” | ISO/IEC 14496-10:2009: “Information technology—Coding of audio-visual objects—Part 10: Advanced Video Coding”.
[2] ISO/IEC 13818-2:2000: “Information technology—Generic coding of moving pictures and associated audio information—Part 2: Video”.

1.-32. (canceled)

33. A method in a video handling entity for compressing N-stream multi-view 3D video, the method comprising:
multiplexing at least some of the N streams of the N-stream multi-view 3D video into one pseudo 2D stream, appearing as a 2D video stream to a 2D encoder, and
providing the pseudo 2D stream to a replaceable 2D encoder which can be replaced with a different 2D encoder, for encoding of the pseudo 2D stream, resulting in encoded data having a 2D codec format.

34. The method according to claim 33, wherein the method further comprises providing said encoded data to at least one of a video handling entity, and a storage unit.

35. The method according to claim 33, wherein metadata related to the multiplexing of the multi-view 3D video is provided.

36. The method according to claim 33, wherein other information is multiplexed into the pseudo 2D stream together with the video streams.

37. The method according to claim 36, wherein the other information includes at least one of depth information, disparity information, occlusion information, segmentation information, and transparency information.

38. The method according to claim 33, further comprising encapsulating said encoded data in a data format indicating encoded 3D video.

39. The method according to claim 33, wherein the number of multiplexed video streams is larger than 2.

40. An arrangement in a video handling entity, adapted to compress N-stream multi-view 3D video, the arrangement comprising:
a multiplexing unit, adapted to multiplex at least some of the N streams of the N-stream multi-view 3D video into one pseudo 2D stream, appearing as a 2D video stream to a 2D video encoder, and further adapted to provide the pseudo 2D stream to a replaceable 2D encoder which can be replaced with a different 2D encoder, for encoding of the pseudo 2D stream, resulting in encoded data having a 2D codec format.

41. The arrangement according to claim 40, further comprising a providing unit, adapted to provide said encoded data to at least one of a video handling entity, and a storage unit.

42. The arrangement according to claim 40, further adapted to provide metadata related to the multiplexing of multi-view 3D video.

43. The arrangement according to claim 40, further adapted to multiplex other information into the pseudo 2D stream, together with the video streams.

44. The arrangement according to claim 43, wherein the other information includes at least one of depth information, disparity information, occlusion information, segmentation information, and transparency information.

45. The arrangement according to claim 40, further comprising an encapsulating unit adapted to encapsulate the encoded data in a data format indicating encoded 3D video.

46. The arrangement according to claim 40, adapted to multiplex more than 2 video streams.

47. A method in a video handling entity for de-compressing N-stream multi-view 3D video, the method comprising:
obtaining data for de-compression,
determining a 2D codec format of obtained 2D-encoded N-stream multi-view 3D video data,
providing said obtained data to a replaceable 2D decoder supporting the determined 2D format which can be replaced with a different 2D decoder, for decoding of the obtained data, resulting in a pseudo 2D video stream, and
de-multiplexing the pseudo 2D video stream into the separate streams of the N-stream multi-view 3D video, comprised in the obtained data.

48. Method according to claim 47, wherein the de-multiplexing is based on metadata related to the multiplexing of the multi-view 3D video.

49. The method according to claim 48, wherein said metadata is, at least partly, comprised in the obtained data.

50. The method according to claim 48, wherein said metadata is, at least partly, implicit.

51. The method according to claim 47, further comprising:
determining whether the obtained data comprises 2D encoded N-stream multi-view 3D video having a 2D codec format based on at least one of:
a data format of the obtained data, and
metadata associated with the obtained data.

52. The method according to claim 47, further comprising:
de-multiplexing the pseudo 2D video stream into the separate streams of the N-stream multi-view 3D video, and into any other information, comprised in the obtained data.

53. The method according to claim 52, wherein the other comprised information includes at least one of depth information, disparity information, occlusion information, segmentation information, and transparency information.

54. The method according to claim 47, wherein the obtained data to be de-compressed comprises at least 3 multiplexed video streams.

55. An arrangement in a video handling entity, adapted to de-compress N-stream multi-view 3D video, the arrangement comprising:
an obtaining unit, adapted to obtain data for de-compression,
a determining unit, adapted to determine a 2D encoding format of obtained 2D-encoded N-stream multi-view 3D video data, and further adapted to provide said obtained data to a replaceable 2D decoder supporting the determined 2D format which can be replaced with a different 2D decoder, for decoding of the obtained data, resulting in a pseudo 2D video stream, and
a de-multiplexing unit, adapted to de-multiplex the pseudo 2D video stream into the separate streams of the N-stream multi-view 3D video, comprised in the obtained data.

56. The arrangement according to claim 55, wherein the de-multiplexing is based on metadata related to the multiplexing of the multi-view 3D video.

57. The arrangement according to claim 56, wherein the metadata is at least partly comprised in the obtained data.

58. The arrangement according to claim 56, wherein the metadata is at least partly implicit.

59. The arrangement according to claim 55, wherein the determining unit is further adapted to determine whether the obtained data comprises 2D-encoded N-stream multi-view 3D video data, based on at least one of the following:
metadata associated with the obtained data, and
the format of the obtained data.

60. The arrangement according to claim 55, further adapted to de-multiplex the pseudo 2D video stream into the separate streams of the N-stream multi-view 3D video, and into any other information, comprised in the obtained data.

61. The arrangement according to claim 60, wherein the other information includes at least one of depth information, disparity information, occlusion information, segmentation information, and transparency information.

62. The arrangement according to claim 55, adapted to de-compress data comprising at least 3 multiplexed video streams.

63. A computer program product stored on a computer readable storage medium and comprising computer program instructions that, when executed in an arrangement in a video handling entity adapted to compress and de-compress N-stream multi-view 3D video, causes the arrangement to perform the steps of:
compressing the N-stream multi-view 3D video comprising:
multiplexing at least some of the N streams of the N-stream multi-view 3D video into one pseudo 2D stream, appearing as a 2D video stream to a 2D encoder; and
providing the pseudo 2D stream to a replaceable 2D encoder which can be replaced with a different 2D encoder, for encoding of the pseudo 2D stream, resulting in encoded data having a 2D codec format; and
de-compressing the N-stream multi-view 3D video comprising:
obtaining data for de-compression;
determining the 2D codec format of obtained 2D-encoded N-stream multi-view 3D video data;
providing said obtained data to a replaceable 2D decoder supporting the determined 2D format which can be replaced with a different 2D decoder, for decoding of the obtained data, resulting in a pseudo 2D video stream; and
de-multiplexing the pseudo 2D video stream into the separate streams of the N-stream multi-view 3D video, comprised in the obtained data.
